(19) United States
(12) Patent Application Publication
(10) Pub. No.: US 2026/0030930 A1
(43) Pub. Date: Jan. 29, 2026

(54) FINGERPRINT ANTI-COUNTERFEITING METHOD AND APPARATUS, ELECTRONIC DEVICE AND STORAGE MEDIUM

(71) Applicant: HUIKE (SINGAPORE) HOLDING PTE. LTD., Singapore (SG)

(72) Inventors: Huiyi HU, Shenzhen (CN); Mengjia XIAO, Shenzhen (CN)

(73) Assignee: HUIKE (SINGAPORE) HOLDING PTE. LTD., Singapore (SG)

(21) Appl. No.: 19/346,909

(22) Filed: Oct. 1, 2025

Related U.S. Application Data
(63) Continuation of application No. PCT/IB2024/062482, filed on Dec. 11, 2024.

(30) Foreign Application Priority Data
Feb. 5, 2024 (CN) 202410171385.1

(51) Int. Cl. G06V 40/40; G01S 15/12; G06V 40/12; G06V 40/13; G06V 40/50

(52) U.S. Cl. CPC G06V 40/45; G01S 15/12; G06V 40/1306; G06V 40/1365; G06V 40/50

(57) ABSTRACT

A fingerprint anti-counterfeiting method and apparatus, an electronic device and a storage medium are provided. The method includes: determining time-domain characteristic information and frequency-domain characteristic information of a target ultrasonic signal, where the target ultrasonic signal is an echo signal reflected back to an ultrasonic fingerprint module within a continuous time interval during which a fingerprint carrier enrolls a fingerprint via the ultrasonic fingerprint module; and determining authenticity of the fingerprint enrolled by the fingerprint carrier via the ultrasonic fingerprint module, based on the time-domain characteristic information and the frequency-domain characteristic information.

### CROSS-REFERENCE TO RELATED APPLICATIONS AND INCORPORATION BY REFERENCE

The present application is a continuation of PCT/IB2024/062482 filed on Dec. 11, 2024 and titled “FINGERPRINT ANTI-COUNTERFEITING METHOD AND APPARATUS, ELECTRONIC DEVICE AND STORAGE MEDIUM”, which claims the priority of Chinese Patent Application No. 202410171385.1 filed on Feb. 5, 2024 and titled “FINGERPRINT ANTI-COUNTERFEITING METHOD AND APPARATUS, ELECTRONIC DEVICE AND STORAGE MEDIUM”, the contents of which are incorporated herein by references in its entireties.

### TECHNICAL FIELD

Embodiments of the present disclosure relate to the technical field of data processing, and in particular to a fingerprint anti-counterfeiting method and apparatus, an electronic device and a storage medium.

### BACKGROUND

An ultrasonic fingerprint module forms a fingerprint image by emitting ultrasonic waves outward and acquiring intensity differences of reflected ultrasonic waves between a finger-screen contact interface and a screen-air contact interface. Unlike optical imaging, ultrasonic sensors use piezoelectric transducers inside to generate ultra-high frequency sound waves that can penetrate a skin epidermis layer, and receive the intensity of reflected sound waves to form images, which is less affected by fingerprint surface details, enabling recognition even when fingers are stained or wet. Currently, ultrasonic fingerprint technology is relatively easy to crack using 2.5D or 3D fake fingerprints. These fake fingerprints may simulate ridges and valleys of real fingers, forming acoustic impedance differences similar to those of real fingers when in contact with the screen, thereby obtaining fingerprint images identical to those of real fingers, leading to reduced user security once approved by a recognition system. Therefore, a new fingerprint anti-counterfeiting solution is needed to at least partially address this issue.

### SUMMARY

In view of this, embodiments of the present disclosure provide a fingerprint anti-counterfeiting method and apparatus, an electronic device and a storage medium, to at least partially solve the above problems.

According to a first aspect of embodiments of the present disclosure, a fingerprint anti-counterfeiting method is provided, including:
determining time-domain characteristic information and frequency-domain characteristic information of a target ultrasonic signal, where the target ultrasonic signal is an echo signal reflected back to an ultrasonic fingerprint module within a continuous time interval during which a fingerprint carrier enrolls a fingerprint via the ultrasonic fingerprint module; and
determining authenticity of the fingerprint enrolled by the fingerprint carrier via the ultrasonic fingerprint module, based on the time-domain characteristic information and the frequency-domain characteristic information.

In some alternative embodiments, the determining time-domain characteristic information and frequency-domain characteristic information of a target ultrasonic signal, includes:
determining a time-domain response curve of the target ultrasonic signal, and determining a time-domain characteristic curve segment corresponding to the echo signal reflected back to the ultrasonic fingerprint module by the fingerprint carrier from the time-domain response curve, and determining information of the time-domain characteristic curve segment as the time-domain characteristic information of the target ultrasonic signal; and
converting the time-domain characteristic curve segment to a frequency domain to obtain a frequency-domain characteristic curve segment, and determining information of the frequency-domain characteristic curve segment as the frequency-domain characteristic information of the target ultrasonic signal.

In some alternative embodiments, the determining a time-domain characteristic curve segment corresponding to the echo signal reflected back to the ultrasonic fingerprint module by the fingerprint carrier from the time-domain response curve, and determining information of the time-domain characteristic curve segment as the time-domain characteristic information of the target ultrasonic signal, includes:
acquiring a reference time-domain characteristic curve of a reference echo signal, and determining peak points on the reference time-domain characteristic curve, where the reference echo signal is an echo signal returned to the ultrasonic fingerprint module when no fingerprint carrier enrolls a fingerprint via the ultrasonic fingerprint module;
determining a time difference between each two adjacent peak points in the peak points, and determining a maximum time difference based on each time difference;
determining a start time value and an end time value of the time-domain characteristic curve segment, based on the maximum time difference and a time value of an earlier peak point among two peak points corresponding to the maximum time difference; and
dividing the time-domain characteristic curve segment from the time-domain response curve, based on the start time value and the end time value, and determining the information of the time-domain characteristic curve segment as the time-domain characteristic information of the target ultrasonic signal.

In some alternative embodiments, the determining a start time value and an end time value of the time-domain characteristic curve segment, based on the maximum time difference and a time value of an earlier peak point among two peak points corresponding to the maximum time difference, includes:
using the time value of the earlier peak point among the two peak points corresponding to the maximum time difference as the start time value, and using the start time value plus the maximum time difference multiplied by a preset multiple as the end time value.

In some alternative embodiments, the preset multiple is 2.

In some alternative embodiments, the frequency-domain characteristic curve segment includes: a first frequency-domain characteristic curve segment and a second frequency-domain characteristic curve segment;
the converting the time-domain characteristic curve segment to a frequency domain to obtain a frequency-domain characteristic curve segment, and determining information of the frequency-domain characteristic curve segment as the frequency-domain characteristic information of the target ultrasonic signal, includes:
performing frequency-domain conversion processing on the time-domain characteristic curve segment to obtain the first frequency-domain characteristic curve segment, and determining information of the first frequency-domain characteristic curve segment as the frequency-domain characteristic information of the target ultrasonic signal; and
performing windowing processing on the time-domain characteristic curve segment to obtain the second frequency-domain characteristic curve segment, and determining information of the second frequency-domain characteristic curve segment as the frequency-domain characteristic information of the target ultrasonic signal.

In some alternative embodiments, the determining authenticity of the fingerprint enrolled by the fingerprint carrier via the ultrasonic fingerprint module, based on the time-domain characteristic information and the frequency-domain characteristic information, includes:
determining multiple determination indicators for indicating whether the fingerprint carrier is a real finger, based on the time-domain characteristic information and the frequency-domain characteristic information; and
determining the authenticity of the fingerprint enrolled by the fingerprint carrier via the ultrasonic fingerprint module, based on the multiple determination indicators and a predetermined condition.

In some alternative embodiments, the determining multiple determination indicators for indicating whether the fingerprint carrier is a real finger, based on the time-domain characteristic information and the frequency-domain characteristic information, includes:
determining multiple time-domain calibration feature points on the time-domain characteristic curve segment, based on multiple calibration feature points on a reference time-domain characteristic curve segment;
determining multiple peak points on the first frequency-domain characteristic curve segment as multiple frequency-domain first calibration feature points;
determining a windowing frequency-domain peak point and a fixed frequency point on the second frequency-domain characteristic curve segment as multiple frequency-domain second calibration feature points; and
determining the multiple determination indicators, based on the multiple time-domain calibration feature points, the multiple frequency-domain first calibration feature points, and the multiple frequency-domain second calibration feature points.

In some alternative embodiments, the determining the authenticity of the fingerprint enrolled by the fingerprint carrier via the ultrasonic fingerprint module, based on the multiple determination indicators and a predetermined condition, includes:
determining, if at least one of the multiple determination indicators does not meet the predetermined condition, the fingerprint to be a fake fingerprint; otherwise, determining the fingerprint to be a real fingerprint.

According to a second aspect of embodiments of the present disclosure, a fingerprint anti-counterfeiting apparatus is provided, including:
a first determination module, configured to determine time-domain characteristic information and frequency-domain characteristic information of a target ultrasonic signal, where the target ultrasonic signal is an echo signal reflected back to an ultrasonic fingerprint module within a continuous time interval during which a fingerprint carrier enrolls a fingerprint via the ultrasonic fingerprint module; and
a second determination module, configured to determine authenticity of the fingerprint enrolled by the fingerprint carrier via the ultrasonic fingerprint module, based on the time-domain characteristic information and the frequency-domain characteristic information.

According to a third aspect of embodiments of the present disclosure, an electronic device is provided, including: a processor, a communication interface, a memory, and a communication bus, where the processor, the communication interface, and the memory communicate with each other via the communication bus; the memory is configured to store a computer program; and the processor is configured to perform the method described in the first aspect by running the computer program stored in the memory.

According to a fourth aspect of embodiments of the present disclosure, a computer storage medium is provided, storing a computer program thereon, the computer program, when executed by a processor, implements the method described in the first aspect.

According to a fifth aspect of embodiments of the present disclosure, a computer program product is provided, including a computer program, the computer program, when executed by a processor, implements the method described in the first aspect.

In the fingerprint anti-counterfeiting solution provided by the embodiments of the present disclosure, since the time-domain characteristic information and the frequency-domain characteristic information of the target ultrasonic signal can be determined, where the target ultrasonic signal is the echo signal reflected back to the ultrasonic fingerprint module within a continuous time interval during which the fingerprint carrier enrolls a fingerprint via the ultrasonic fingerprint module, and then the authenticity of the fingerprint enrolled by the fingerprint carrier via the ultrasonic fingerprint module is determined based on the time-domain characteristic information and the frequency-domain characteristic information. Therefore, the fingerprint anti-counterfeiting solution in the embodiments of the present disclosure no longer determines the authenticity of an enrolled fingerprint by identifying fingerprint image frames formed during fingerprint enrolling using the ultrasonic fingerprint module. Instead, the solution analyzes the time-domain and frequency-domain characteristics of the ultrasonic echo signal reflected back to the ultrasonic fingerprint module within a continuous signal time interval to determine the authenticity of the enrolled fingerprint. In this way, this solution may effectively achieve the fingerprint anti-counterfeiting function by analyzing signal characteristic differences in ultrasonic reflected echoes between real fingers and fake fingers, reducing the likelihood of erroneous determination, thereby achieving a good fingerprint anti-counterfeiting effect, ensuring user security.

### BRIEF DESCRIPTION OF DRAWINGS

In order to more clearly illustrate the technical solution in embodiments of the present disclosure or the prior art, the accompanying drawings to be used in the description of the embodiments or the prior art will be briefly introduced below. Obviously, the accompanying drawings in the following description are only some of the embodiments recorded in the embodiments of the present disclosure, and those of ordinary skill in the art may also obtain other accompanying drawings based on these accompanying drawings.

FIG. 1a is a schematic diagram of a signal emission model for emitting an ultrasonic signal of an ultrasonic fingerprint module in an embodiment of the present disclosure.

FIG. 1b is a schematic diagram of a signal reception model for receiving an echo signal of the ultrasonic fingerprint module in an embodiment of the present disclosure.

FIG. 2a is a schematic diagram of example curves of a finger epidermis layer echo signal and a finger dermis layer echo signal.

FIG. 2b is a schematic diagram of example curves of an echo signal when not covered by a fingerprint carrier (such as finger) and an echo signal when a finger enrolls a fingerprint on a screen.

FIG. 3 is a flowchart illustrating steps of an exemplary fingerprint anti-counterfeiting method in an embodiment of the present disclosure.

FIG. 4 is a flowchart of an optional sub-step in step S102 in an embodiment of the present disclosure.

FIG. 5 is a flowchart of an optional sub-step in step S1021 in an embodiment of the present disclosure.

FIG. 6a is a schematic diagram of curves of a time-domain response curve and a time-domain characteristic curve segment of a real finger in some example real-world scenarios.

FIG. 6b is a schematic diagram of curves of a time-domain response curve and a time-domain characteristic curve segment of a fake finger (pressed by finger) in some example real-world scenarios.

FIG. 6c is a schematic diagram of curves of a time-domain response curve and a time-domain characteristic curve segment of a fake finger (pressed by mold) in some example real-world scenarios.

FIG. 7 is a flowchart of an optional sub-step in step S1022 in an embodiment of the present disclosure.

FIG. 8 is a flowchart of an optional sub-step in step S104 in an embodiment of the present disclosure.

FIG. 9 is a flowchart of an optional sub-step in step S1041 in an embodiment of the present disclosure.

FIG. 10 is a schematic diagram of example curves of a time-domain characteristic curve segment, first frequency-domain characteristic curve segment, and second frequency-domain characteristic curve segment.

FIGS. 11a, 11b, 11c, 11d, 11e, 11f, 11g, 11h and 11i are schematic diagrams of example curves of time-domain characteristic curve segments, first frequency-domain characteristic curve segments, and second frequency-domain characteristic curve segments corresponding to real fingerprint and two types of fake fingerprints, respectively.

FIG. 12 is a flowchart illustrating steps of an example specific implementation of the fingerprint anti-counterfeiting method in an embodiment of the present disclosure.

FIG. 13 is a structural block diagram of an exemplary fingerprint anti-counterfeiting apparatus in an embodiment of the present disclosure.

FIG. 14 is a structural block diagram of an exemplary electronic device in an embodiment of the present disclosure.

### DETAILED DESCRIPTION

In order to enable those in the art to better understand the technical solution in embodiments of the present disclosure, the technical solution in the embodiments of the present disclosure will be described clearly and completely in the following in conjunction with the accompanying drawings in the embodiments of the present disclosure. It is obvious that the described embodiments are only some of the embodiments in the embodiments of the present disclosure, but not all of the embodiments. Based on the embodiments of the present disclosure, all other embodiments obtained by those of ordinary skill in the art shall fall within the scope of protection of the embodiments of the present disclosure. It should be understood that steps described in the method embodiments of the present disclosure may be performed in different orders and/or in parallel. In addition, the method embodiments may include additional steps and/or omit performing the steps shown. The scope of the present disclosure is not limited in this regard.

The term “including” and its variations used herein are open-ended inclusions, indicating “including but not limited to.” The term “based on” indicates “at least partially based on.” The term “an embodiment” indicates “at least one embodiment”; the term “another embodiment” indicates “at least one additional embodiment”; and the term “some embodiments” indicates “at least some embodiments.” Definitions of other terms will be provided in the descriptions below. It should be noted that the terms “first”, “second”, etc., as used in the embodiments of the present disclosure, are only used to distinguish between different apparatuses, modules, or units and are not intended to limit the order or interdependence of functions performed by these apparatuses, modules, or units. It should be noted that the modifiers “one”, or “multiple” used in the embodiments of the present disclosure are illustrative rather than restrictive. Those skilled in the art should understand that, unless otherwise explicitly stated in the context, these terms should be interpreted as “one or more.”

An ultrasonic fingerprint module forms a fingerprint image by emitting ultrasonic waves outward and acquiring intensity differences of reflected ultrasonic waves between a finger-screen contact interface and a screen-air contact interface. Unlike optical imaging, ultrasonic sensors use piezoelectric transducers inside to generate ultra-high frequency sound waves that can penetrate a skin epidermis layer, and receive the intensity of reflected sound waves to form images, which is less affected by fingerprint surface details, enabling recognition even when fingers are stained or wet. Currently, ultrasonic fingerprint technology is relatively easy to crack using 2.5D or 3D fake fingerprints. These fake fingerprints may simulate ridges and valleys of real fingers, forming acoustic impedance differences similar to those of real fingers when in contact with the screen, thereby obtaining fingerprint images identical to those of real fingers, leading to reduced user security once approved by a recognition system.

In related technologies, in order to perform fingerprint anti-counterfeiting on a fingerprint enrolled by an ultrasonic fingerprint module, the general method is to determine authenticity of the enrolled fingerprint by identifying fingerprint image frames formed during fingerprint enrolling using the ultrasonic fingerprint module. However, this method is prone to erroneous determination, resulting in poor fingerprint anti-counterfeiting effect, thus making it difficult to ensure user security.

In view of this, the fingerprint anti-counterfeiting method in the embodiments of the present disclosure determines authenticity of a fingerprint enrolled by a fingerprint carrier via an ultrasonic fingerprint module based on a target ultrasonic signal of the ultrasonic fingerprint module, so as to effectively improve the fingerprint anti-counterfeiting effect.

Specific implementation of the embodiments of the present disclosure is further described below in conjunction with the accompanying drawings of the embodiments of the present disclosure.

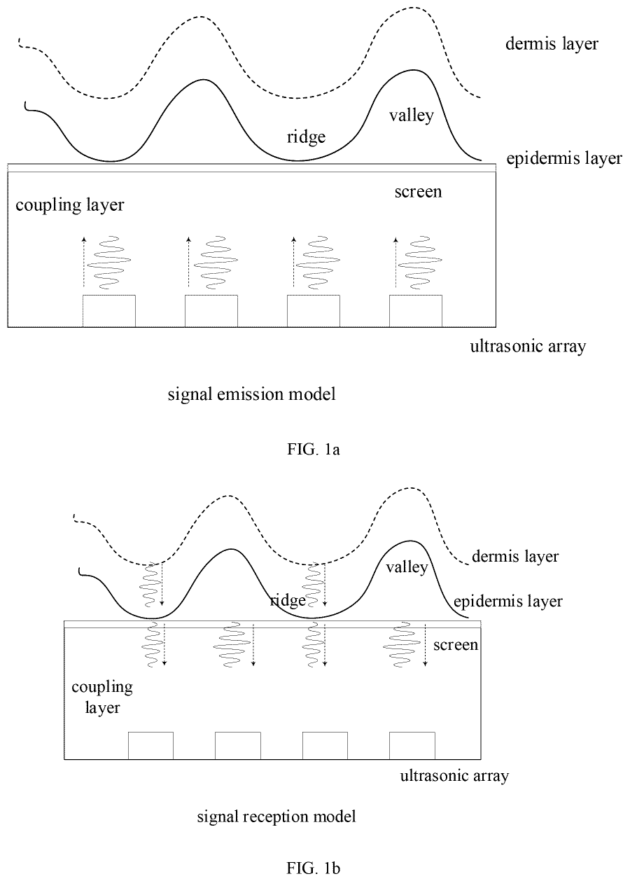

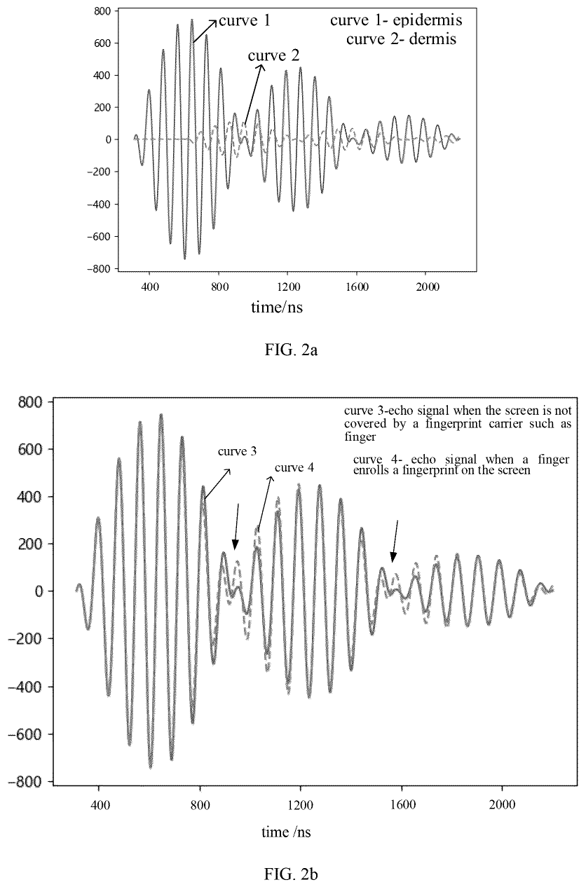

In the embodiments of the present disclosure, an ultrasonic array used in the ultrasonic fingerprint module may be formed by PVDF (polyvinylidene difluoride). In a fingerprint recognition scenario, as shown in FIG. 1a, a signal emission model emits an ultrasonic signal through the ultrasonic array. As shown in FIG. 1b, the ultrasonic signal is reflected by the fingerprint carrier after passing through a coupling layer of a screen, and a signal reception model receives an echo signal reflected back through the ultrasonic array. Specifically, the ultrasonic array emits the ultrasonic signal to the screen at a fixed frequency, which penetrates the screen to reach a finger epidermis layer, through transmission and reflection, part of the ultrasonic waves enters a finger dermis layer, then undergoes another round of transmission and reflection, and the ultrasonic array receives the echo signal within a continuous time interval. Since the ultrasonic signal reaching the finger dermis layer travels farther, its echo timing lags and may be superimposed with a subsequent finger epidermis layer echo, forming small peaks of the echo signal, as shown in a waveform of FIG. 2a. Here, curve 1 in FIG. 2a is a finger epidermis layer echo signal, and curve 2 is a finger dermis layer echo signal (it should be understood that curve 1 is represented by a solid line, and curve 2 is represented by a dashed line for easy distinction). Curve 3 in FIG. 2b is an echo signal when the screen is not covered by the fingerprint carrier such as finger, which is also known as a reference time-domain characteristic curve of a reference echo signal; curve 4 is an echo signal when a finger enrolls a fingerprint on the screen (it should be understood that curve 3 is represented by a solid line, and curve 4 is represented by a dashed line for easy distinction). Arrows point to small peaks of the echo signal when a finger enrolls a fingerprint on the screen, i.e., the small peaks generated by the superposition of the finger epidermis layer echo signal and the finger dermis layer echo signal.

There are significant differences in acoustic impedance between a real finger and a fake finger, and the sound velocity varies in varied materials, thereby affecting the echo signal. A real finger has both the dermis layer and the epidermis layer, while fake finger products are made of uniform materials without epidermal and dermal layers, leading to corresponding differences in echo signal characteristics.

Therefore, the fingerprint anti-counterfeiting solution in the embodiments of the present disclosure no longer determines the authenticity of an enrolled fingerprint by identifying fingerprint image frames formed during fingerprint enrolling using the ultrasonic fingerprint module. Instead, the solution analyzes the time-domain and frequency-domain characteristics of the ultrasonic echo signal reflected back to the ultrasonic fingerprint module within a continuous signal time interval to determine the authenticity of the enrolled fingerprint. In this way, this solution may effectively achieve the fingerprint anti-counterfeiting function by analyzing signal characteristic differences in ultrasonic reflected echoes between real fingers and fake fingers, reducing the likelihood of erroneous determination, thereby achieving a good fingerprint anti-counterfeiting effect, ensuring user security.

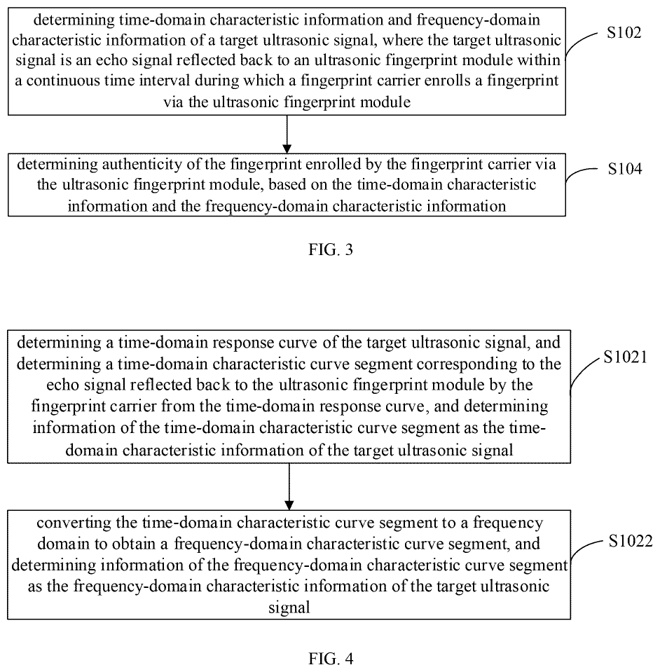

FIG. 3 is a flowchart illustrating steps of an exemplary fingerprint anti-counterfeiting method in an embodiment of the present disclosure. As shown in FIG. 3, the fingerprint anti-counterfeiting method includes steps S102 and S104, specifically:
Step S102: determining time-domain characteristic information and frequency-domain characteristic information of a target ultrasonic signal, where the target ultrasonic signal is an echo signal reflected back to an ultrasonic fingerprint module within a continuous time interval during which a fingerprint carrier enrolls a fingerprint via the ultrasonic fingerprint module.

In this embodiment of the present disclosure, the ultrasonic fingerprint module collects multiple frames of ultrasonic signals. The time intervals between the multiple frames of ultrasonic signals collected in a continuous time period may be different, for example, 5 ns, 10 ns, etc. Therefore, different from the use of frame data to achieve the fingerprint anti-counterfeiting function, the ultrasonic fingerprint module in this embodiment of the present disclosure collects multiple frames of ultrasonic signals within a continuous time interval to achieve the fingerprint anti-counterfeiting function.
Step S104: determining authenticity of the fingerprint enrolled by the fingerprint carrier via the ultrasonic fingerprint module, based on the time-domain characteristic information and the frequency-domain characteristic information.

In the fingerprint anti-counterfeiting solution provided by embodiments of the present disclosure, since the time-domain characteristic information and the frequency-domain characteristic information of the target ultrasonic signal can be determined, where the target ultrasonic signal is the echo signal reflected back to the ultrasonic fingerprint module within a continuous time interval during which the fingerprint carrier enrolls a fingerprint via the ultrasonic fingerprint module, and then the authenticity of the fingerprint enrolled by the fingerprint carrier via the ultrasonic fingerprint module is determined based on the time-domain characteristic information and the frequency-domain characteristic information. Therefore, the fingerprint anti-counterfeiting solution in the embodiments of the present disclosure no longer determines the authenticity of an enrolled fingerprint by identifying fingerprint image frames formed during fingerprint enrolling using the ultrasonic fingerprint module. Instead, the solution analyzes the time-domain and frequency-domain characteristics of the ultrasonic echo signal reflected back to the ultrasonic fingerprint module within a continuous signal time interval to determine the authenticity of the enrolled fingerprint. In this way, this solution may effectively achieve the fingerprint anti-counterfeiting function by analyzing signal characteristic differences in ultrasonic reflected echoes between real fingers and fake fingers, reducing the likelihood of erroneous determination, thereby achieving a good fingerprint anti-counterfeiting effect, ensuring user security.

In some alternative embodiments, referring to FIG. 4, the step S102 includes:
Step S1021: determining a time-domain response curve of the target ultrasonic signal, and determining a time-domain characteristic curve segment corresponding to the echo signal reflected back to the ultrasonic fingerprint module by the fingerprint carrier from the time-domain response curve, and determining information of the time-domain characteristic curve segment as the time-domain characteristic information of the target ultrasonic signal.
Step S1022: converting the time-domain characteristic curve segment to a frequency domain to obtain a frequency-domain characteristic curve segment, and determining information of the frequency-domain characteristic curve segment as the frequency-domain characteristic information of the target ultrasonic signal.

In this embodiment of the present disclosure, the time-domain characteristic curve segment is determined from the time-domain response curve within a continuous time interval, by converting the time-domain characteristic curve segment to the frequency domain, the frequency-domain characteristic curve segment can be determined, thereby determining the time-domain characteristic information and the frequency-domain characteristic information. In this embodiment of the present disclosure, the time-domain characteristic information and the frequency-domain characteristic information can be easily determined to achieve the fingerprint anti-counterfeiting function.

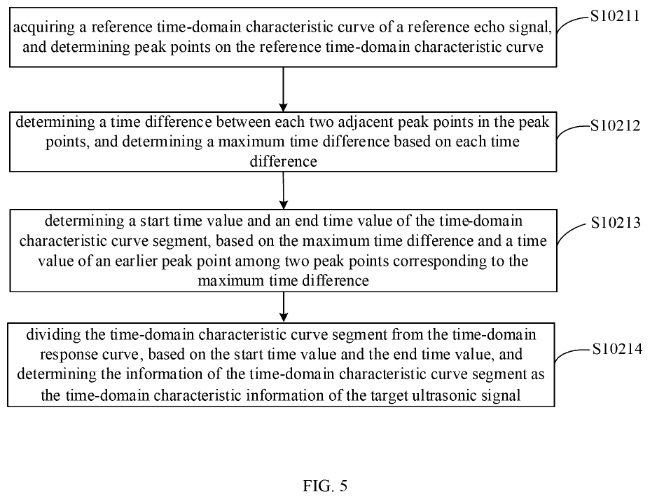

In some alternative embodiments, referring to FIG. 5, the step S1021 includes:
Step S10211: acquiring a reference time-domain characteristic curve of a reference echo signal, and determining peak points on the reference time-domain characteristic curve.

The reference echo signal is an echo signal returned to the ultrasonic fingerprint module when no fingerprint carrier enrolls a fingerprint via the ultrasonic fingerprint module.
Step S10212: determining a time difference between each two adjacent peak points in the peak points, and determining a maximum time difference based on each time difference.
Step S10213: determining a start time value and an end time value of the time-domain characteristic curve segment, based on the maximum time difference and a time value of an earlier peak point among two peak points corresponding to the maximum time difference.
Step S10214: dividing the time-domain characteristic curve segment from the time-domain response curve, based on the start time value and the end time value, and determining the information of the time-domain characteristic curve segment as the time-domain characteristic information of the target ultrasonic signal.

Based on the start time value and the end time value determined from the reference echo signal, the corresponding time-domain response curve may divide a curve segment between the start time value and the end time value in the time-domain response curve, thereby obtaining the time-domain characteristic curve segment.

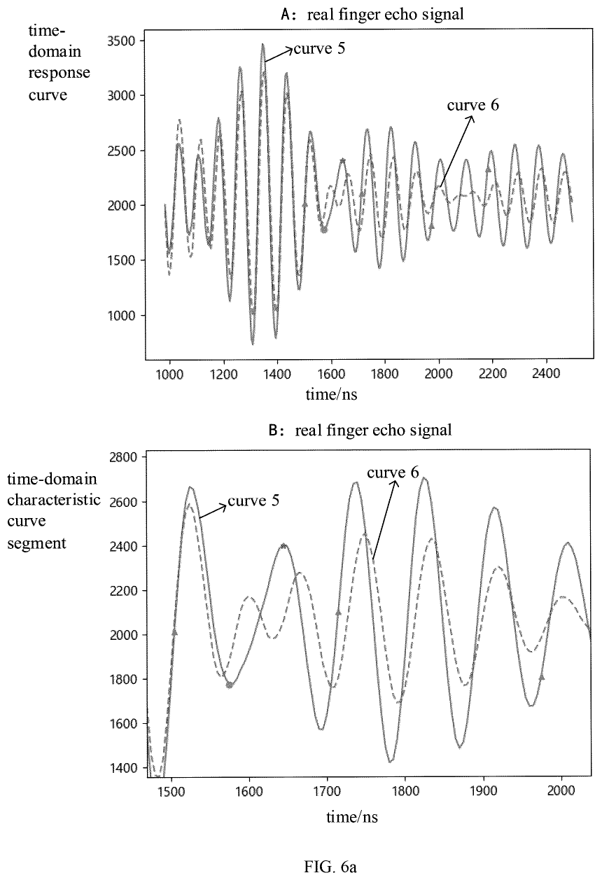

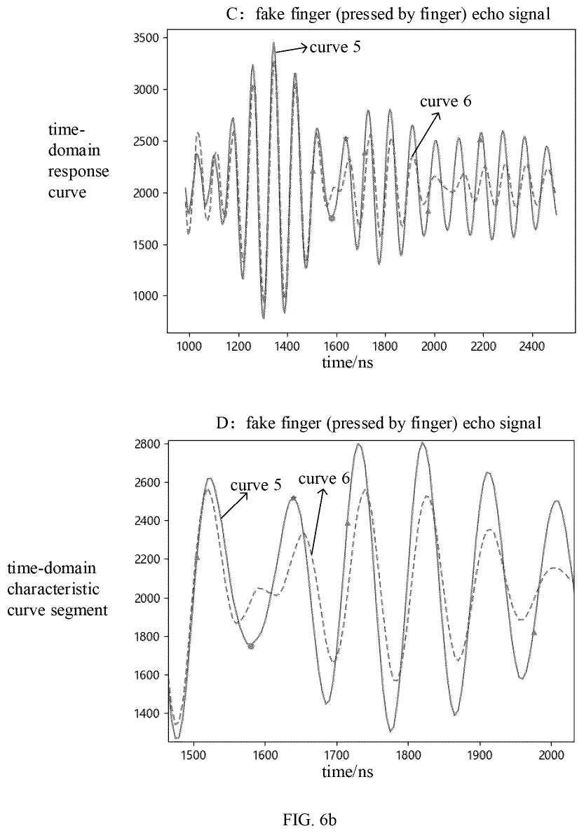

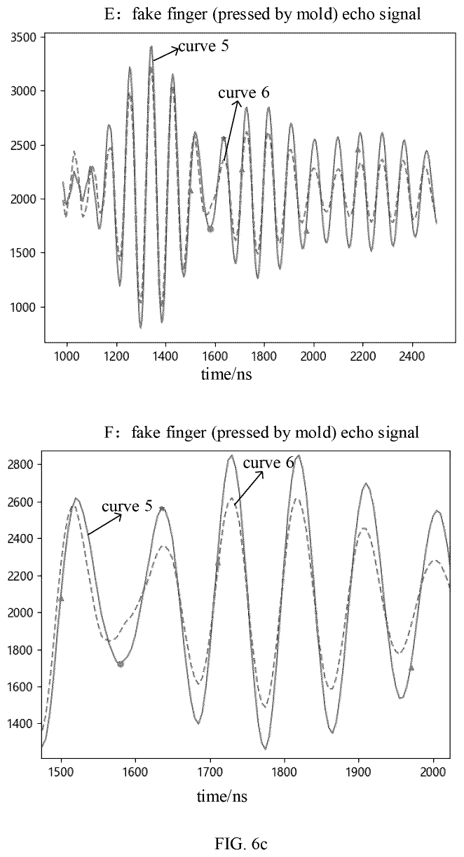

In combination with FIGS. 6a, 6b and 6c, referring to sub-figure A and sub-figure B in FIG. 6a, which are respectively a time-domain response curve and a time-domain characteristic curve segment of a real finger echo signal in real-world scenarios; referring to sub-figure C and sub-figure D in FIG. 6b, which are respectively a time-domain response curve and a time-domain characteristic curve segment of a fake finger (pressed by finger) echo signal in real-world scenarios; referring to sub-figure E and sub-figure F in FIG. 6c, which are respectively a time-domain response curve and a time-domain characteristic curve segment of a fake finger (pressed by mold) echo signal in real-world scenarios. Here, curve 5 in each figure is the reference time-domain characteristic curve of the reference echo signal (it should be understood that curve 5 in each figure is shown with a solid line for easy distinction); curve 6 in each figure is the time-domain response curve of the echo signal showing periodic changes (it should be understood that curve 6 in each figure is shown with a dashed line for easy distinction). The time-domain response curve of the echo signal shows periodic changes. The position of small peaks generated by the superposition of the finger epidermis layer echo signal and the finger dermis layer echo signal is related to a period of the time-domain response curve of the echo signal. Therefore, the time-domain characteristic curve segment where the small peaks is located may be obtained by detecting the period of the time-domain response curve of the echo signal. The position where a period of the reference time-domain characteristic curve of the reference echo signal changes is a reflected echo through the screen. If a finger touches the screen to generate an echo signal, there are small peaks formed by the superposition of the finger epidermis layer echo signal and the finger dermis layer echo signal near this time. Therefore, this feature interval may be calibrated by the reference time-domain characteristic curve of the reference echo signal, and response curve characteristics of this feature interval may be used to identify between real and fake fingers.

In particular, mark subscript pᵢ of each peak point on the reference time-domain characteristic curve of the reference echo signal, and calculate the time difference between each two adjacent peak points in the peak points, that is, the period Tₚ_{ᵢ}=pᵢ₊₁−pᵢ. Mark the maximum time difference in the time differences in subscript interval (pᵢ, p_{i+1.}) of the maximum period. Therefore, in this embodiment of the present disclosure, the time-domain characteristic curve segment corresponding to the period of the reference time-domain characteristic curve of the reference echo signal may be easily and reasonably determined from the time-domain response curve by using the subscript interval (pᵢ, p_{i+1.}) of the maximum period, and this characteristic curve segment includes the small peaks generated by the superposition of the epidermis layer echo signal and the finger dermis layer echo signal, and real and fake fingers may be identified based on the response curve characteristics of the feature interval.

In some alternative embodiments, the step S10213, includes: using the time value of the earlier peak point among the two peak points corresponding to the maximum time difference as the start time value, and using the start time value plus the maximum time difference multiplied by a preset multiple as the end time value.

In this embodiment of the present disclosure, by using the time value of the earlier peak point among the two peak points corresponding to the maximum time difference as the start time value, and using the start time value plus the maximum time difference multiplied by the preset multiple as the end time value, then dividing the obtained time-domain characteristic curve segment from the time-domain response curve, it may be ensured that the small peaks generated by the superposition of the epidermis layer echo signal and the finger dermis layer echo signal can be covered more accurately, thereby reducing subsequent calculations.

In this embodiment of the present disclosure, the preset multiple may be set by those skilled in the art as needed. The preset multiple may be greater than 1. For example, it may be set to 2, 3, etc. For example, the start time value plus 2 times of the maximum time difference is used as the end time value. For example, the start time value may be pᵢ, and the end time value may be pᵢ₊₂, that is, the time-domain characteristic curve segment at the time value (pᵢ, p_{i+2.}) may be divided from the time-domain response curve. It may be simply understood here that (pᵢ, p_{i+2.}) is equal to 2 times of the subscript interval (pᵢ, p_{i+1.}) of the maximum period, which may also be understood in combination with the previous text. In some alternative embodiments of the present disclosure, 2 times of the maximum time difference may be used, which not only ensures that the small peaks generated by the superposition of the epidermis layer echo signal and the finger dermis layer echo signal can be completely and accurately covered, but also prevents the divided time-domain characteristic curve segment from being too long, which is more convenient to reduce the subsequent calculations.

In some alternative embodiments, the frequency-domain characteristic curve segment includes: a first frequency-domain characteristic curve segment and a second frequency-domain characteristic curve segment.

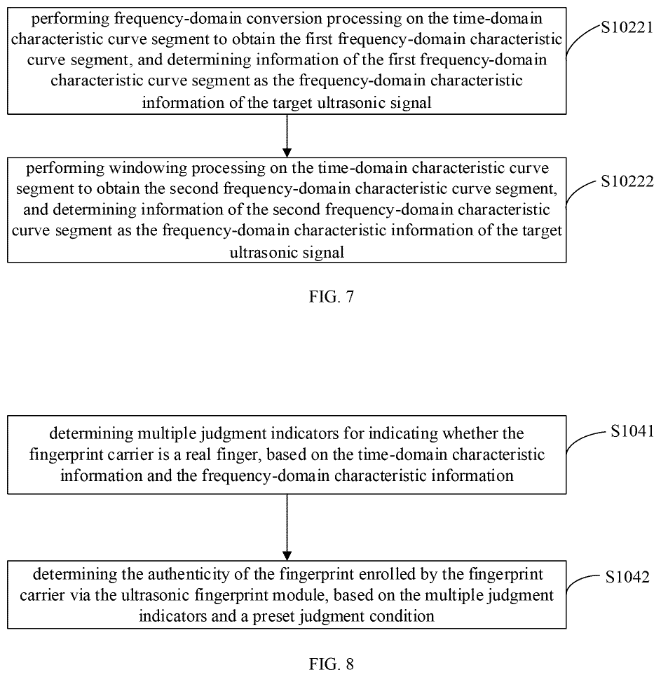

In some alternative embodiments, referring to FIG. 7, the step S1022 includes:
Step S10221: performing frequency-domain conversion processing on the time-domain characteristic curve segment to obtain the first frequency-domain characteristic curve segment, and determining information of the first frequency-domain characteristic curve segment as the frequency-domain characteristic information of the target ultrasonic signal.
Step S10222: performing windowing processing on the time-domain characteristic curve segment to obtain the second frequency-domain characteristic curve segment, and determining information of the second frequency-domain characteristic curve segment as the frequency-domain characteristic information of the target ultrasonic signal.

In this embodiment of the present disclosure, the frequency-domain characteristic curve segment corresponding to the time-domain characteristic curve segment may be obtained by time domain-frequency domain conversion and time-domain windowing, and the information of the frequency-domain characteristic curve segment may be determined as the frequency-domain characteristic information of the target ultrasonic signal. In this embodiment of the present disclosure, the frequency-domain characteristic information can be easily determined to achieve the fingerprint anti-counterfeiting function.

In some alternative embodiments, referring to FIG. 8, the step S104 includes:
Step S1041: determining multiple determination indicators for indicating whether the fingerprint carrier is a real finger, based on the time-domain characteristic information and the frequency-domain characteristic information.
Step S1042: determining the authenticity of the fingerprint enrolled by the fingerprint carrier via the ultrasonic fingerprint module, based on the multiple determination indicators and a predetermined condition.

In this embodiment of the present disclosure, the authenticity of the fingerprint enrolled by the fingerprint carrier via the ultrasonic fingerprint module is determined based on the multiple determination indicators and the predetermined condition, so that the authenticity of the fingerprint may be easily determined.

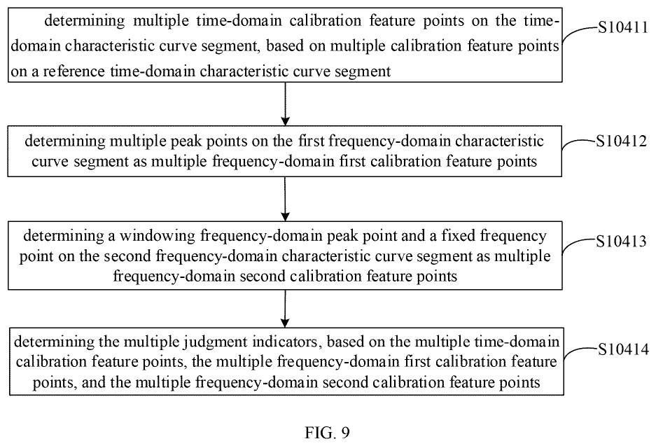

In some alternative embodiments, referring to FIG. 9, the step S1041 includes:
Step S10411: determining multiple time-domain calibration feature points on the time-domain characteristic curve segment, based on multiple calibration feature points on a reference time-domain characteristic curve segment.
Step S10412: determining multiple peak points on the first frequency-domain characteristic curve segment as multiple frequency-domain first calibration feature points.
Step S10413: determining a windowing frequency-domain peak point and a fixed frequency point on the second frequency-domain characteristic curve segment as multiple frequency-domain second calibration feature points.
Step S10414: determining the multiple determination indicators, based on the multiple time-domain calibration feature points, the multiple frequency-domain first calibration feature points, and the multiple frequency-domain second calibration feature points.

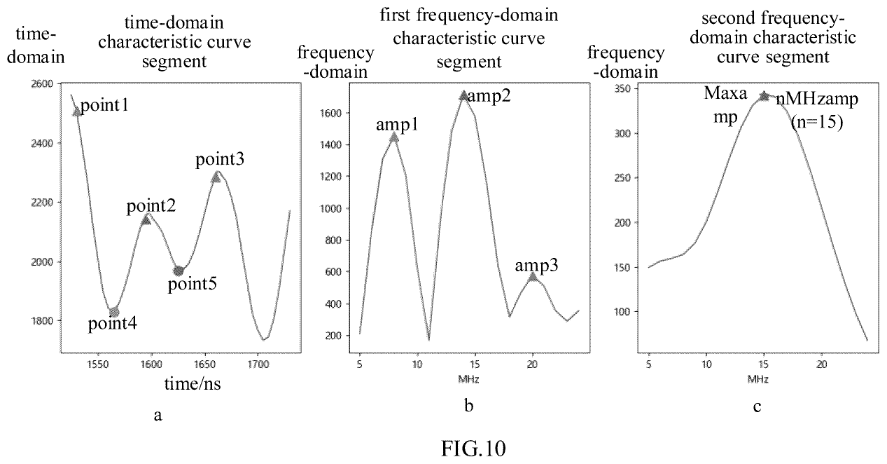

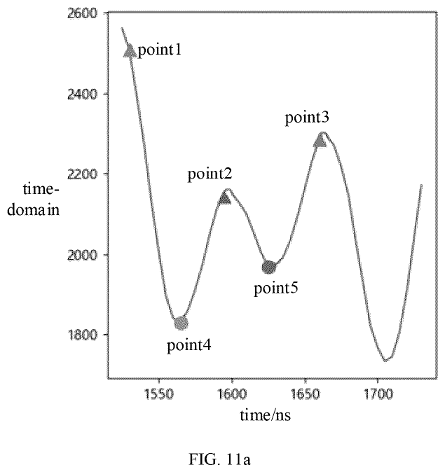

Alternatively, the reference time-domain characteristic curve segment may be obtained by calibration in advance based on a real finger before fingerprint anti-counterfeiting. For example, the time-domain response curve of the echo signal of the real finger may be collected according to the aforementioned method, and then the time-domain characteristic curve segment (here also the reference time-domain characteristic curve segment) may be obtained from the time-domain response curve. For example, the multiple calibration feature points may be selected from peaks and valleys on the reference time-domain characteristic curve segment, and time corresponding to the multiple calibration feature points may be recorded. The above steps S10411-S10414 form a fingerprint anti-counterfeiting phase. Then, when using this method for fingerprint anti-counterfeiting, step S10411 may be performed to find multiple points corresponding to the time corresponding to the multiple calibration feature points from the obtained time-domain characteristic curve segment as the multiple time-domain calibration feature points. For example, five time-domain calibration feature points on the time-domain characteristic curve segment may be determined. As shown in sub-figure a in FIG. 10, five time-domain calibration feature points (point1, point2, point3, point4, point5) are determined from the time-domain characteristic curve segment. In the example shown in the figure, a part of the five time-domain calibration feature points are exactly the peaks and valleys on the time-domain characteristic curve segment.

For example, three frequency-domain first calibration feature points on the first frequency-domain characteristic curve segment may be determined. As shown in sub-figure b in FIG. 10, three frequency-domain first calibration feature points (amp1, amp2, amp3) are selected from the peaks on the first frequency-domain characteristic curve segment.

Alternatively, the fixed frequency point may be set as needed based on a signal emission frequency of the ultrasonic array. For example, two frequency-domain second calibration feature points on the second frequency-domain characteristic curve segment may be determined. As shown in sub-figure c in FIG. 10, two frequency-domain second calibration feature points (Maxₐₘₚ, nMHzₐₘₚ) are determined from the windowing frequency-domain peak point and the fixed frequency point on the second frequency-domain characteristic curve segment. Referring to sub-figure c in FIG. 10, n=15 is shown in the example here, that is, the fixed frequency point nMHzₐₘₚ is the point 15 MHzₐₘₚ corresponding to 15 MHz.

In some alternative embodiments, the step S1042, includes: determining, if at least one of the multiple determination indicators does not meet the predetermined condition, the fingerprint to be a fake fingerprint; otherwise, determining the fingerprint to be a real fingerprint.

Alternatively, an example solution of the above step S10414 is: determining five determination indicators, based on 5 time-domain calibration feature points, 3 frequency-domain first calibration feature points, and 2 frequency-domain second calibration feature points, including:

$${m}_{1} = point 2 - point 4$$

$${m}_{2} = point 2 - point 5$$

$${m}_{3} = n {MHz}_{amp} / {Max}_{amp}$$

$${m}_{4} = \frac{\vert amp 1 - amp 2 \vert}{max ( amp 1 , amp 2 , amp 3 )}$$

$${m}_{5} = \vert amp 1 - amp 2 \vert$$

Here, m₁, m₂, m₃, m₄ and m₅ are the five determination indicators. The 5 time-domain calibration feature points are: point1, point2, point3, point4, and point5. The 3 frequency-domain first calibration feature points are: amp1, amp2, and amp3. The 2 frequency-domain second calibration feature points are: Maxₐₘₚ and nMHzₐₘₚ. When calculating the above five formulas, vertical coordinate values of the calibration feature points are substituted for the calculation.

If the conditions m₁>0, m₂>0, m₃>threshold 1, m₄<threshold 2, m₅<threshold 3 are met, the fingerprint is a real fingerprint. If any one of the conditions is not met, it is a fake fingerprint. Threshold 1, threshold 2, and threshold 3 are determined according to actual conditions.

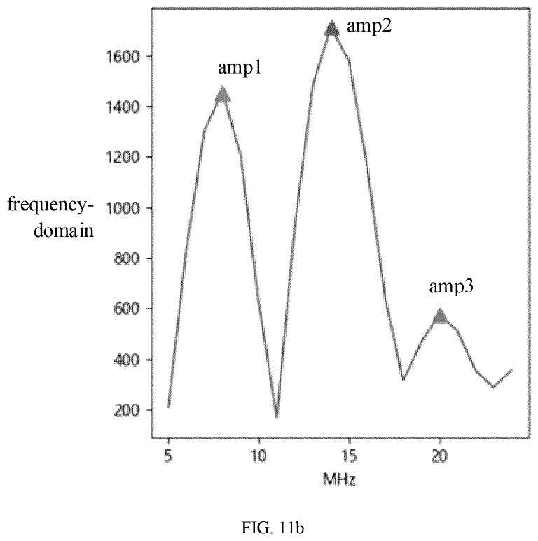

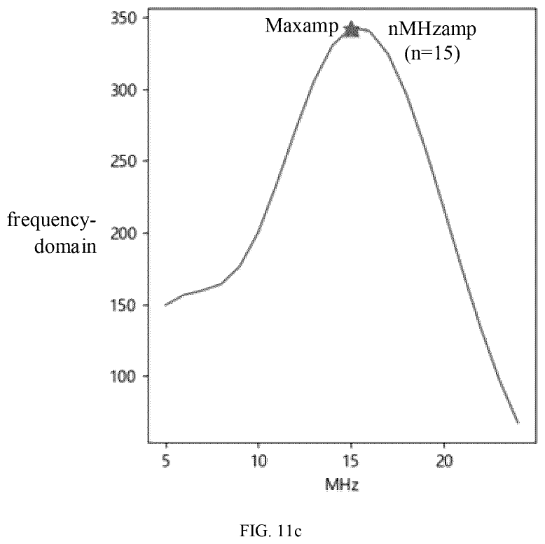

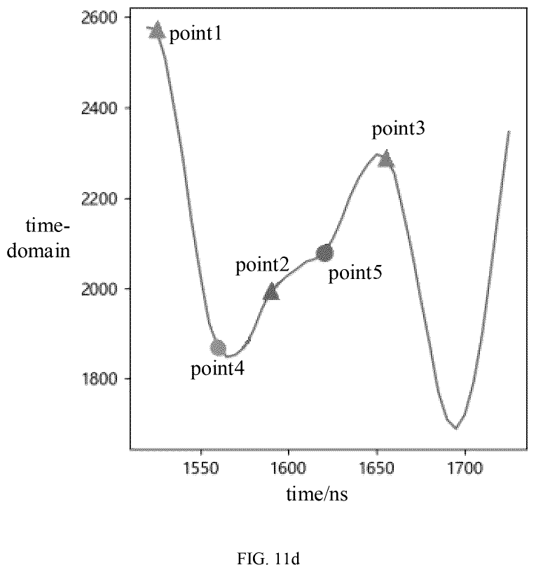

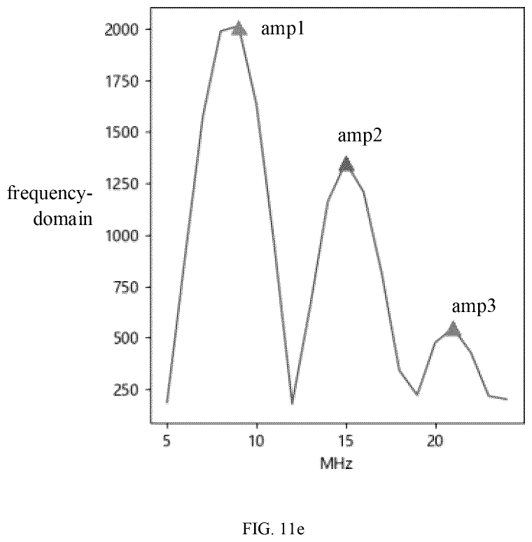

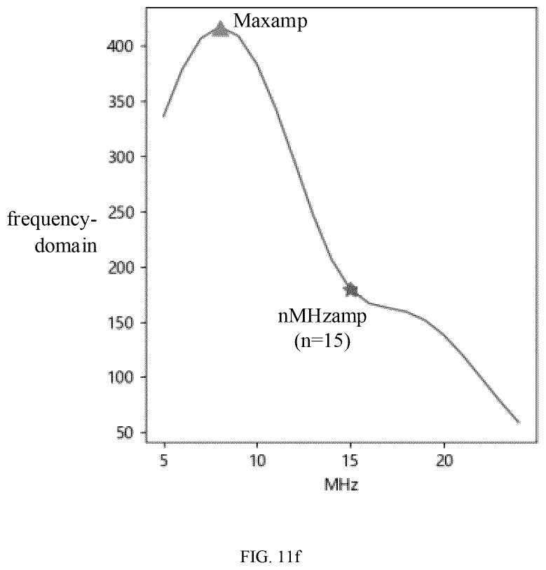

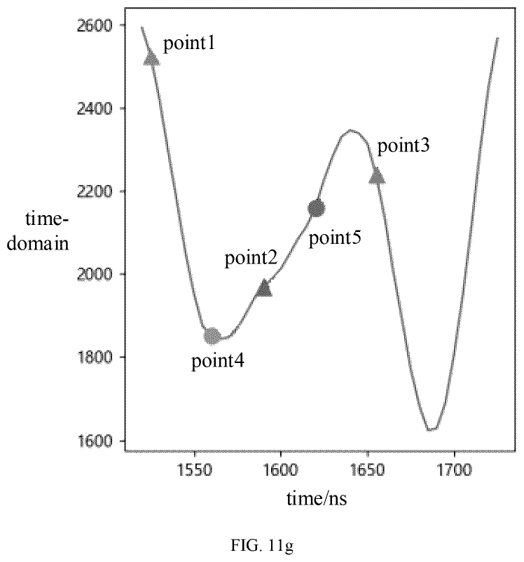

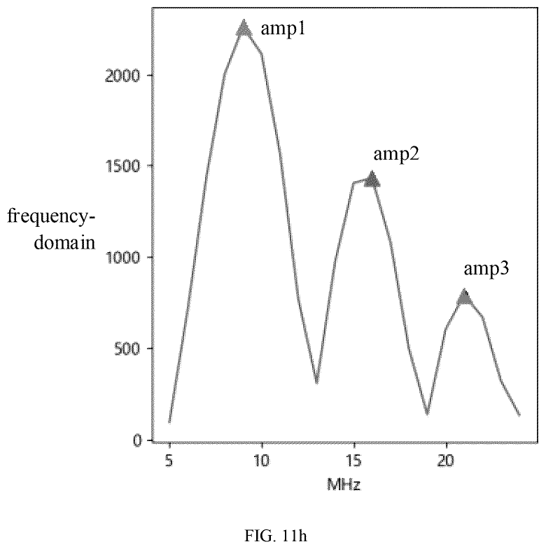

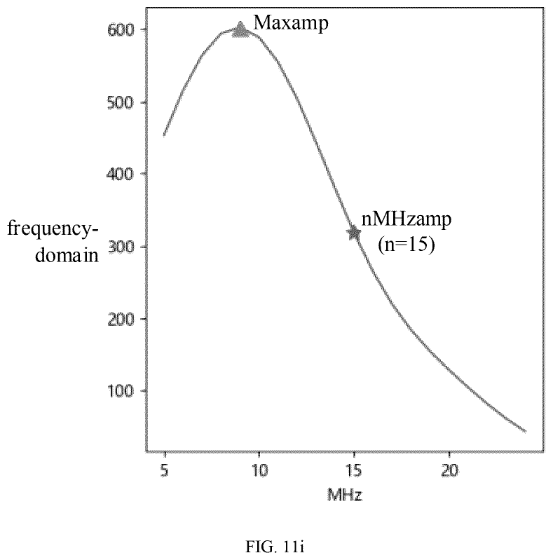

For example, the comparison between real fingerprint and fake fingerprints is as shown in FIGS. 11a, 11b, 11c, 11d, 11e, 11f, 11g, 11h and 11i. Specifically, a real fingerprint time-domain characteristic curve segment is shown in FIG. 11a. A real fingerprint first frequency-domain characteristic curve segment is shown in FIG. 11b. A real fingerprint second frequency-domain characteristic curve segment is shown in FIG. 11c. A fake finger pressed by finger time-domain characteristic curve segment is shown in FIG. 11d. A fake finger pressed by finger first frequency-domain characteristic curve segment is shown in FIG. 11e. A fake finger pressed by finger second frequency-domain characteristic curve segment is shown in FIG. 11f. A fake finger pressed by mold time-domain characteristic curve segment is shown in FIG. 11g. A fake finger pressed by mold first frequency-domain characteristic curve segment is shown in FIG. 11h. A fake finger pressed by mold second frequency-domain characteristic curve segment is shown in FIG. 11i. The determination indicators determined by the time-domain calibration feature points and frequency-domain calibration feature points corresponding to the real fingerprint may fully meet the above predetermined condition, while the determination indicators determined by the time-domain calibration feature points and frequency-domain calibration feature points corresponding to the fake fingerprints (fake fingerprint pressed by finger and fake fingerprint pressed by mold) cannot fully meet the above predetermined condition. Therefore, fingerprint anti-counterfeiting may be performed by using the above predetermined condition to effectively judge between real fingerprints and fake fingerprints. In addition, it can be seen that the solution in the embodiments of the present disclosure may effectively achieve the fingerprint anti-counterfeiting function by analyzing signal characteristic differences in ultrasonic reflected echoes between real fingers (corresponding to real fingerprints) and fake fingers (corresponding to fake fingerprints), reducing the likelihood of erroneous determination, thereby achieving a good fingerprint anti-counterfeiting effect, ensuring user security.

It may be understood that the above description of the fingerprint anti-counterfeiting method is only an exemplary description of embodiments of the present disclosure, and does not constitute any limitation to the embodiments of the present disclosure.

The implementation of embodiments of the present disclosure is described in detail below through a specific application.

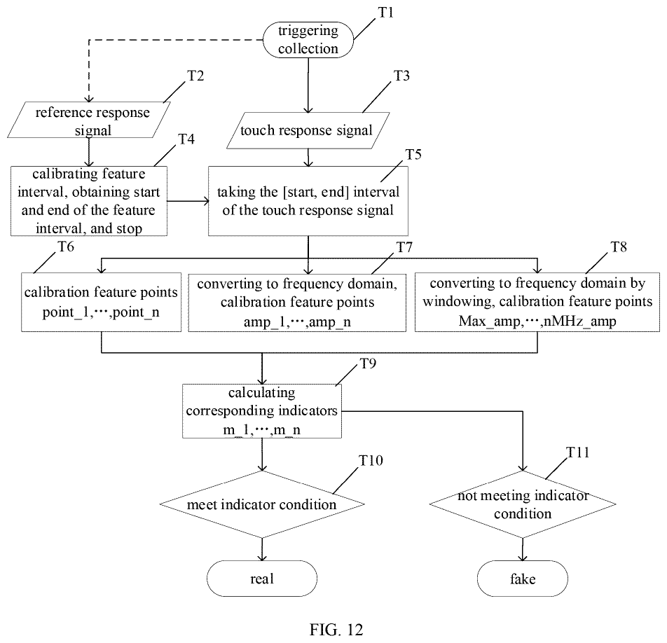

Alternatively, referring to FIG. 12, the fingerprint anti-counterfeiting method includes:
Step T1: triggering an ultrasonic fingerprint module to collect an echo signal.
Step T2: acquiring a reference time-domain characteristic curve of a reference echo signal. If a user change is not detected, this step is not necessary, and a pre-stored reference time-domain characteristic curve of a reference echo signal may be used.
Step T3: acquiring a time-domain response curve of a target ultrasonic signal.
Step T4: determining a start time value and an end time value of a time-domain characteristic curve segment in the reference time-domain characteristic curve of the reference echo signal.
Step T5: determining the start time value and the end time value of the time-domain characteristic curve segment, using the start time value and the end time value of the time-domain characteristic curve segment in the reference time-domain characteristic curve of the reference echo signal, and dividing the time-domain characteristic curve segment from the time-domain response curve.
Step T6: determining multiple time-domain calibration feature points on the time-domain characteristic curve segment, based on multiple calibration feature points on a reference time-domain characteristic curve segment.
Step T7: performing frequency-domain conversion processing on the time-domain characteristic curve segment to obtain the first frequency-domain characteristic curve segment, and determining multiple peak points on the second frequency-domain characteristic curve segment as multiple frequency-domain second calibration feature points.
Step T8: performing windowing processing on the time-domain characteristic curve segment to obtain the second frequency-domain characteristic curve segment, and determining a windowing frequency-domain peak point and a fixed frequency point on the second frequency-domain characteristic curve segment as multiple frequency-domain second calibration feature points.
Step T9: determining the multiple determination indicators, based on the multiple time-domain calibration feature points, the multiple frequency-domain first calibration feature points, and the multiple frequency-domain second calibration feature points.
Step T10: determining, if the multiple determination indicators all meet the predetermined condition, the fingerprint to be a real fingerprint.
Step T11: Otherwise, determining the fingerprint to be a fake fingerprint.

It should be understood that the above specific application is only an alternative embodiment and does not constitute any limitation to the embodiments of the present disclosure.

In summary, the fingerprint anti-counterfeiting solution in the embodiments of the present disclosure no longer determines the authenticity of an enrolled fingerprint by identifying fingerprint image frames formed during fingerprint enrolling using the ultrasonic fingerprint module. Instead, the solution analyzes the time-domain and frequency-domain characteristics of the ultrasonic echo signal reflected back to the ultrasonic fingerprint module within a continuous signal time interval to determine the authenticity of the enrolled fingerprint. In this way, the solution may effectively achieve the fingerprint anti-counterfeiting function by analyzing signal characteristic differences in ultrasonic reflected echoes between real fingers and fake fingers, reducing the likelihood of erroneous determination, thereby achieving a good fingerprint anti-counterfeiting effect, ensuring user security.

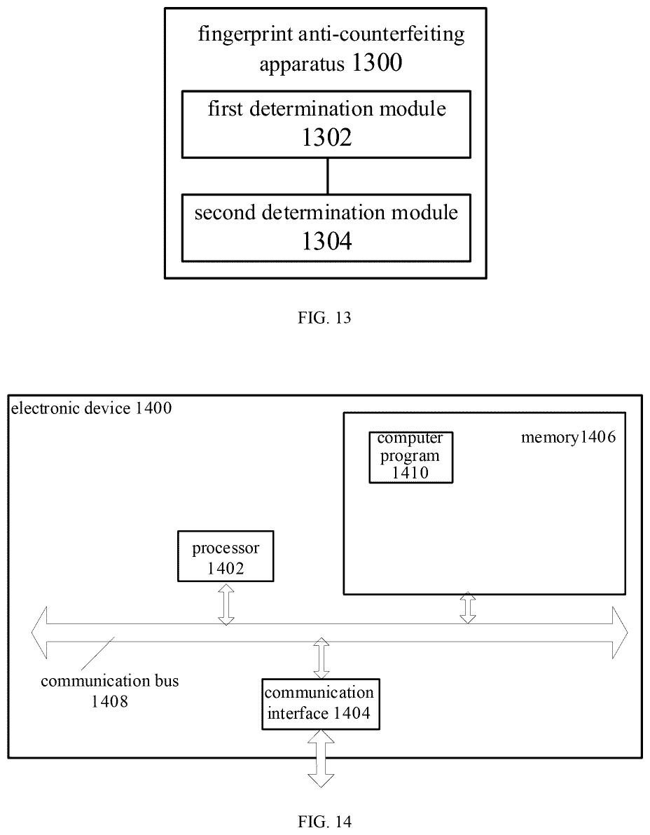

According to a second aspect of embodiments of the present disclosure, a fingerprint anti-counterfeiting apparatus is provided. FIG. 13 illustrates a structural block diagram of an exemplary fingerprint anti-counterfeiting apparatus 1300 in an embodiment of the present disclosure. The fingerprint anti-counterfeiting apparatus 1300 in this embodiment of the present disclosure includes:

a first determination module 1302, configured to determine time-domain characteristic information and frequency-domain characteristic information of a target ultrasonic signal, where the target ultrasonic signal is an echo signal reflected back to an ultrasonic fingerprint module within a continuous time interval during which a fingerprint carrier enrolls a fingerprint via the ultrasonic fingerprint module; and

a second determination module 1304, configured to determine authenticity of the fingerprint enrolled by the fingerprint carrier via the ultrasonic fingerprint module, based on the time-domain characteristic information and the frequency-domain characteristic information.

In the fingerprint anti-counterfeiting solution provided by the embodiments of the present disclosure, since the time-domain characteristic information and the frequency-domain characteristic information of the target ultrasonic signal can be determined, where the target ultrasonic signal is the echo signal reflected back to the ultrasonic fingerprint module within a continuous time interval during which the fingerprint carrier enrolls a fingerprint via the ultrasonic fingerprint module, and then the authenticity of the fingerprint enrolled by the fingerprint carrier via the ultrasonic fingerprint module is determined based on the time-domain characteristic information and the frequency-domain characteristic information. Therefore, the fingerprint anti-counterfeiting solution in the embodiments of the present disclosure no longer determines the authenticity of an enrolled fingerprint by identifying fingerprint image frames formed during fingerprint enrolling using the ultrasonic fingerprint module. Instead, the solution analyzes the time-domain and frequency-domain characteristics of the ultrasonic echo signal reflected back to the ultrasonic fingerprint module within a continuous signal time interval to determine the authenticity of the enrolled fingerprint. In this way, this solution may effectively achieve the fingerprint anti-counterfeiting function by analyzing signal characteristic differences in ultrasonic reflected echoes between real fingers and fake fingers, reducing the likelihood of erroneous determination, thereby achieving a good fingerprint anti-counterfeiting effect, ensuring user security.

In some alternative embodiments, the first determination module 1302 is specifically configured to: determine a time-domain response curve of the target ultrasonic signal, and determine a time-domain characteristic curve segment corresponding to the echo signal reflected back to the ultrasonic fingerprint module by the fingerprint carrier from the time-domain response curve, and determine information of the time-domain characteristic curve segment as the time-domain characteristic information of the target ultrasonic signal; and convert the time-domain characteristic curve segment to a frequency domain to obtain a frequency-domain characteristic curve segment, and determine information of the frequency-domain characteristic curve segment as the frequency-domain characteristic information of the target ultrasonic signal.

In some alternative embodiments, the first determination module 1302 is specifically configured to: acquire a reference time-domain characteristic curve of a reference echo signal, and determine peak points on the reference time-domain characteristic curve, where the reference echo signal is an echo signal returned to the ultrasonic fingerprint module when no fingerprint carrier enrolls a fingerprint via the ultrasonic fingerprint module; determine a time difference between each two adjacent peak points in the peak points, and determine a maximum time difference based on each time difference; determine a start time value and an end time value of the time-domain characteristic curve segment, based on the maximum time difference and a time value of an earlier peak point among two peak points corresponding to the maximum time difference; and divide the time-domain characteristic curve segment from the time-domain response curve, based on the start time value and the end time value, and determine the information of the time-domain characteristic curve segment as the time-domain characteristic information of the target ultrasonic signal.

In some alternative embodiments, the first determination module 1302 is specifically configured to: use the time value of the earlier peak point among the two peak points corresponding to the maximum time difference as the start time value, and use the start time value plus the maximum time difference multiplied by a preset multiple as the end time value.

In some alternative embodiments, the preset multiple is 2.

In some alternative embodiments, the frequency-domain characteristic curve segment includes: a first frequency-domain characteristic curve segment and a second frequency-domain characteristic curve segment; the first determination module 1302 is specifically configured to: perform frequency-domain conversion processing on the time-domain characteristic curve segment to obtain the first frequency-domain characteristic curve segment, and determine information of the first frequency-domain characteristic curve segment as the frequency-domain characteristic information of the target ultrasonic signal; and perform windowing processing on the time-domain characteristic curve segment to obtain the second frequency-domain characteristic curve segment, and determine information of the second frequency-domain characteristic curve segment as the frequency-domain characteristic information of the target ultrasonic signal.

In some alternative embodiments, the second determination module 1304 is specifically configured to: determine multiple determination indicators for indicating whether the fingerprint carrier is a real finger, based on the time-domain characteristic information and the frequency-domain characteristic information; and determine the authenticity of the fingerprint enrolled by the fingerprint carrier via the ultrasonic fingerprint module, based on the multiple determination indicators and a predetermined condition.

In some alternative embodiments, the second determination module 1304 is specifically configured to: determine multiple time-domain calibration feature points on the time-domain characteristic curve segment, based on multiple calibration feature points on a reference time-domain characteristic curve segment; determine multiple peak points on the first frequency-domain characteristic curve segment as multiple frequency-domain first calibration feature points; determine a windowing frequency-domain peak point and a fixed frequency point on the second frequency-domain characteristic curve segment as multiple frequency-domain second calibration feature points; and determine the multiple determination indicators, based on the multiple time-domain calibration feature points, the multiple frequency-domain first calibration feature points, and the multiple frequency-domain second calibration feature points.

In some alternative embodiments, the second determination module 1304 is specifically configured to: determine, if at least one of the multiple determination indicators does not meet the predetermined condition, the fingerprint to be a fake fingerprint; otherwise, determine the fingerprint to be a real fingerprint.

The fingerprint anti-counterfeiting apparatus 1300 in this embodiment of the present disclosure is based on the same inventive concept as the fingerprint anti-counterfeiting method provided in the first aspect above, and is used to implement the corresponding fingerprint anti-counterfeiting method in the aforementioned multiple method embodiments, and has the beneficial effects of the corresponding method embodiments, detailed description thereof will be omitted herein. In addition, functional implementation of the modules in the fingerprint anti-counterfeiting apparatus 1300 in this embodiment of the present disclosure may refer to the description of the corresponding parts in the aforementioned method embodiments, detailed description thereof will also be omitted herein.

According to a third aspect of embodiments of the present disclosure, an electronic device is provided, including: a processor, a communication interface, a memory, and a communication bus, where the processor, the communication interface, and the memory communicate with each other via the communication bus; the memory is configured to store a computer program; and the processor is configured to perform the fingerprint anti-counterfeiting method described in the first aspect by running the computer program stored in the memory.

FIG. 14 illustrates a structural block diagram of an alternative electronic device in an embodiment of the present disclosure. In this embodiment of the present disclosure, specific implementation of the electronic device 1400 is not limited. As an example, referring to FIG. 14, the electronic device 1400 provided in this embodiment of the present disclosure includes: a processor 1402, a communication interface 1404, a memory 1406, and a communication bus 1408.

The processor 1402, the communication interface 1404, and the memory 1406 communicate with each other via the communication bus 1408.

The communication interface 1404 is configured to communicate with other electronic devices or servers.

The processor 1402 is configured to execute a computer program 1410, which may specifically execute relevant steps in any one of the aforementioned fingerprint anti-counterfeiting method embodiments.

Specifically, the computer program 1410 may include a program code, which includes a computer operation instruction.

The processor 1402 may be a Central Processing Unit (CPU), or an Application Specific Integrated Circuit (ASIC), or one or more integrated circuits configured to implement embodiments of the present disclosure. One or more processors included in a smart device may be processors of the same type, such as one or more CPUs; or different types of processors, such as one or more CPUs and one or more ASICs.

The memory 1406 is configured to store the computer program 1410. The memory 1406 may include a high-speed RAM memory, and may also include a non-volatile memory, such as at least one disk memory.

The computer program 1410 may be specifically used to enable the processor 1402 to perform the fingerprint anti-counterfeiting method in any one of the aforementioned embodiments.

The specific implementation of each step in the computer program 1410 may refer to the corresponding description of the corresponding step and unit in any one of the aforementioned fingerprint anti-counterfeiting method embodiments, detailed description thereof will be omitted herein. Those skilled in the art may clearly understand that for the convenience and simplicity of description, the specific working process of the above-described devices and modules may refer to the corresponding process description in the aforementioned method embodiments, detailed description thereof will be omitted herein.

The electronic device 1400 in an embodiment of the present disclosure has been described in detail in the aforementioned fingerprint anti-counterfeiting method embodiments, therefore, its related contents and beneficial effects may be understood with reference to the aforementioned method embodiments, detailed description thereof will be omitted herein.

According to a fourth aspect of embodiments of the present disclosure, a computer storage medium is provided, storing a computer program thereon, the computer program, when executed by a processor, implements the fingerprint anti-counterfeiting method described in the first aspect.

According to a fifth aspect of embodiments of the present disclosure, a computer program product is provided, including a computer program, the computer program, when executed by a processor, implements the fingerprint anti-counterfeiting method described in the first aspect.

The fingerprint anti-counterfeiting apparatus 1300/electronic device 1400/computer storage medium/computer program product in embodiments of the present disclosure have been described in detail in the aforementioned fingerprint anti-counterfeiting method embodiments, therefore, their related contents and beneficial effects may be understood with reference to the aforementioned method embodiments, detailed description thereof will be omitted herein.

It should be noted that depending on the needs of implementation, the various components/steps described in the embodiments of the present disclosure may be divided into more components/steps, or two or more components/steps, or parts of the components/steps, may be combined into new components/steps to achieve the objectives of the embodiments of the present disclosure.

The above method according to embodiments of the present disclosure may be implemented in hardware, firmware, or implemented as software or computer code that can be stored in a recording medium (such as a CD ROM, RAM, floppy disk, hard disk or magneto-optical disk), or implemented as a computer code originally stored in a remote recording medium or a non-temporary machine-readable medium downloaded through a network and to be stored in a local recording medium, so that the method described herein may be processed by such software stored on a recording medium using a general-purpose computer, a dedicated processor or programmable or dedicated hardware (such as an ASIC or FPGA). It may be understood that a computer, a processor, a microprocessor controller or programmable hardware includes a storage component (e.g., RAM, ROM, flash memory, etc.) that can store or receive software or computer code, and when the software or computer code is accessed and executed by the computer, the processor or hardware, the method described herein is implemented. In addition, when the general-purpose computer accesses the code for implementing the method shown herein, the execution of the code converts the general-purpose computer into a dedicated computer for performing the method shown herein.

Those skilled in the art may recognize that the units and method steps described in the examples disclosed herein in the embodiments can be implemented using electronic hardware, or a combination of computer software and electronic hardware. Whether these functions are executed in hardware or software depends on the specific application and design constraints of the technical solution. Those skilled in the art may use different methods to implement the described functions for each specific application, but such implementation should not be considered to fall outside the scope of the embodiments of the present disclosure.

The above embodiments are provided for illustrative purposes only and are not intended to limit the scope of the present disclosure. Those skilled in the art may make various changes and modifications without departing from the spirit and scope of the embodiments of the present disclosure. Therefore, all equivalent technical solutions also fall within the scope of the embodiments of the present disclosure, and the scope of patent protection of the embodiments of the present disclosure should be defined by the claims.

1. A fingerprint anti-counterfeiting method, comprising:
determining time-domain characteristic information and frequency-domain characteristic information of a target ultrasonic signal, wherein the target ultrasonic signal is an echo signal reflected back to an ultrasonic fingerprint module within a continuous time interval during which a fingerprint carrier enrolls a fingerprint via the ultrasonic fingerprint module; and
determining authenticity of the fingerprint enrolled by the fingerprint carrier via the ultrasonic fingerprint module, based on the time-domain characteristic information and the frequency-domain characteristic information.

2. The method according to claim 1, wherein the determining time-domain characteristic information and frequency-domain characteristic information of a target ultrasonic signal, comprises:
determining a time-domain response curve of the target ultrasonic signal, and determining a time-domain characteristic curve segment corresponding to the echo signal reflected back to the ultrasonic fingerprint module by the fingerprint carrier from the time-domain response curve, and determining information of the time-domain characteristic curve segment as the time-domain characteristic information of the target ultrasonic signal; and
converting the time-domain characteristic curve segment to a frequency domain to obtain a frequency-domain characteristic curve segment, and determining information of the frequency-domain characteristic curve segment as the frequency-domain characteristic information of the target ultrasonic signal.

3. The method according to claim 2, wherein the determining a time-domain characteristic curve segment corresponding to the echo signal reflected back to the ultrasonic fingerprint module by the fingerprint carrier from the time-domain response curve, and determining information of the time-domain characteristic curve segment as the time-domain characteristic information of the target ultrasonic signal, comprises:
acquiring a reference time-domain characteristic curve of a reference echo signal, and determining peak points on the reference time-domain characteristic curve, wherein the reference echo signal is an echo signal returned to the ultrasonic fingerprint module when no fingerprint carrier enrolls a fingerprint via the ultrasonic fingerprint module;
determining a time difference between each two adjacent peak points in the peak points, and determining a maximum time difference based on each time difference;
determining a start time value and an end time value of the time-domain characteristic curve segment, based on the maximum time difference and a time value of an earlier peak point among two peak points corresponding to the maximum time difference; and
dividing the time-domain characteristic curve segment from the time-domain response curve, based on the start time value and the end time value, and determining the information of the time-domain characteristic curve segment as the time-domain characteristic information of the target ultrasonic signal.

4. The method according to claim 3, wherein the determining a start time value and an end time value of the time-domain characteristic curve segment, based on the maximum time difference and a time value of an earlier peak point among two peak points corresponding to the maximum time difference, comprises:
using the time value of the earlier peak point among the two peak points corresponding to the maximum time difference as the start time value, and using the start time value plus the maximum time difference multiplied by a preset multiple as the end time value.

5. The method according to claim 4, wherein the preset multiple is 2.

6. The method according to claim 2, wherein the frequency-domain characteristic curve segment comprises: a first frequency-domain characteristic curve segment and a second frequency-domain characteristic curve segment;
the converting the time-domain characteristic curve segment to a frequency domain to obtain a frequency-domain characteristic curve segment, and determining information of the frequency-domain characteristic curve segment as the frequency-domain characteristic information of the target ultrasonic signal, comprises:
performing frequency-domain conversion processing on the time-domain characteristic curve segment to obtain the first frequency-domain characteristic curve segment, and determining information of the first frequency-domain characteristic curve segment as the frequency-domain characteristic information of the target ultrasonic signal; and
performing windowing processing on the time-domain characteristic curve segment to obtain the second frequency-domain characteristic curve segment, and determining information of the second frequency-domain characteristic curve segment as the frequency-domain characteristic information of the target ultrasonic signal.

7. The method according to claim 6, wherein the determining authenticity of the fingerprint enrolled by the fingerprint carrier via the ultrasonic fingerprint module, based on the time-domain characteristic information and the frequency-domain characteristic information, comprises:
determining multiple determination indicators for indicating whether the fingerprint carrier is a real finger, based on the time-domain characteristic information and the frequency-domain characteristic information; and
determining the authenticity of the fingerprint enrolled by the fingerprint carrier via the ultrasonic fingerprint module, based on the multiple determination indicators and a predetermined condition.

8. The method according to claim 7, wherein the determining multiple determination indicators for indicating whether the fingerprint carrier is a real finger, based on the time-domain characteristic information and the frequency-domain characteristic information, comprises:
determining multiple time-domain calibration feature points on the time-domain characteristic curve segment, based on multiple calibration feature points on a reference time-domain characteristic curve segment;
determining multiple peak points on the first frequency-domain characteristic curve segment as multiple frequency-domain first calibration feature points;
determining a windowing frequency-domain peak point and a fixed frequency point on the second frequency-domain characteristic curve segment as multiple frequency-domain second calibration feature points; and
determining the multiple determination indicators, based on the multiple time-domain calibration feature points, the multiple frequency-domain first calibration feature points, and the multiple frequency-domain second calibration feature points.

9. The method according to claim 8, wherein the determining the authenticity of the fingerprint enrolled by the fingerprint carrier via the ultrasonic fingerprint module, based on the multiple determination indicators and a predetermined condition, comprises:
determining, if at least one of the multiple determination indicators does not meet the predetermined condition, the fingerprint to be a fake fingerprint; otherwise, determining the fingerprint to be a real fingerprint.

10. A fingerprint anti-counterfeiting apparatus, comprising:
a first determination module, configured to determine time-domain characteristic information and frequency-domain characteristic information of a target ultrasonic signal, wherein the target ultrasonic signal is an echo signal reflected back to an ultrasonic fingerprint module within a continuous time interval during which a fingerprint carrier enrolls a fingerprint via the ultrasonic fingerprint module; and
a second determination module, configured to determine authenticity of the fingerprint enrolled by the fingerprint carrier via the ultrasonic fingerprint module, based on the time-domain characteristic information and the frequency-domain characteristic information.

11. The apparatus according to claim 10, wherein the first determination module is configured to: determine a time-domain response curve of the target ultrasonic signal, and determine a time-domain characteristic curve segment corresponding to the echo signal reflected back to the ultrasonic fingerprint module by the fingerprint carrier from the time-domain response curve, and determine information of the time-domain characteristic curve segment as the time-domain characteristic information of the target ultrasonic signal; and convert the time-domain characteristic curve segment to a frequency domain to obtain a frequency-domain characteristic curve segment, and determine information of the frequency-domain characteristic curve segment as the frequency-domain characteristic information of the target ultrasonic signal.

12. The apparatus according to claim 11, wherein the first determination module is configured to: acquire a reference time-domain characteristic curve of a reference echo signal, and determine peak points on the reference time-domain characteristic curve, wherein the reference echo signal is an echo signal returned to the ultrasonic fingerprint module when no fingerprint carrier enrolls a fingerprint via the ultrasonic fingerprint module; determine a time difference between each two adjacent peak points in the peak points, and determine a maximum time difference based on each time difference; determine a start time value and an end time value of the time-domain characteristic curve segment, based on the maximum time difference and a time value of an earlier peak point among two peak points corresponding to the maximum time difference; and divide the time-domain characteristic curve segment from the time-domain response curve, based on the start time value and the end time value, and determine the information of the time-domain characteristic curve segment as the time-domain characteristic information of the target ultrasonic signal.

13. The apparatus according to claim 12, wherein the first determination module is configured to: use the time value of the earlier peak point among the two peak points corresponding to the maximum time difference as the start time value, and use the start time value plus the maximum time difference multiplied by a preset multiple as the end time value.

14. The apparatus according to claim 10, wherein the frequency-domain characteristic curve segment comprises: a first frequency-domain characteristic curve segment and a second frequency-domain characteristic curve segment;
the first determination module is configured to: perform frequency-domain conversion processing on the time-domain characteristic curve segment to obtain the first frequency-domain characteristic curve segment, and determine information of the first frequency-domain characteristic curve segment as the frequency-domain characteristic information of the target ultrasonic signal; and perform windowing processing on the time-domain characteristic curve segment to obtain the second frequency-domain characteristic curve segment, and determine information of the second frequency-domain characteristic curve segment as the frequency-domain characteristic information of the target ultrasonic signal.

15. The apparatus according to claim 14, wherein the second determination module is configured to: determine multiple determination indicators for indicating whether the fingerprint carrier is a real finger, based on the time-domain characteristic information and the frequency-domain characteristic information; and determine the authenticity of the fingerprint enrolled by the fingerprint carrier via the ultrasonic fingerprint module, based on the multiple determination indicators and a predetermined condition.

16. The apparatus according to claim 15, wherein the second determination module is configured to: determine multiple time-domain calibration feature points on the time-domain characteristic curve segment, based on multiple calibration feature points on a reference time-domain characteristic curve segment; determine multiple peak points on the first frequency-domain characteristic curve segment as multiple frequency-domain first calibration feature points;
determine a windowing frequency-domain peak point and a fixed frequency point on the second frequency-domain characteristic curve segment as multiple frequency-domain second calibration feature points; and determine the multiple determination indicators, based on the multiple time-domain calibration feature points, the multiple frequency-domain first calibration feature points, and the multiple frequency-domain second calibration feature points.

17. The apparatus according to claim 16, wherein the second determination module is configured to: determine, if at least one of the multiple determination indicators does not meet the predetermined condition, the fingerprint to be a fake fingerprint; otherwise, determine the fingerprint to be a real fingerprint.

18. An electronic device, comprising: a processor, a communication interface, a memory, and a communication bus, wherein the processor, the communication interface, and the memory communicate with each other via the communication bus;
the memory is configured to store a computer program; and
the processor is configured to perform a fingerprint anti-counterfeiting method by running the computer program stored in the memory, the method comprising:
determining time-domain characteristic information and frequency-domain characteristic information of a target ultrasonic signal, wherein the target ultrasonic signal is an echo signal reflected back to an ultrasonic fingerprint module within a continuous time interval during which a fingerprint carrier enrolls a fingerprint via the ultrasonic fingerprint module; and
determining authenticity of the fingerprint enrolled by the fingerprint carrier via the ultrasonic fingerprint module, based on the time-domain characteristic information and the frequency-domain characteristic information.

19. A computer storage medium, storing a computer program thereon, the computer program, when executed by a processor, implements the method according to claim 1.

20. A computer program product, comprising a computer program, the computer program, when executed by a processor, implements the method according to claim 1.
